(19) United States
(12) Patent Application Publication
(10) Pub. No.: US 2015/0248874 A1
(43) Pub. Date: Sep. 3, 2015

(54) MONEY HANDLING SYSTEM, MONEY HANDLING APPARATUS AND MONEY HANDLING METHOD

(71) Applicants: Seiji KIYOSE, (US); Shoichiro MACHIDA, (US)

(72) Inventors: Seiji Kiyose, Hyogo-ken (JP); Shoichiro Machida, Hyogo-ken (JP)

(73) Assignee: GLORY LTD., Himeji-shi, Hyogo-ken (JP)

(21) Appl. No.: 14/428,395

(22) PCT Filed: Sep. 28, 2012
(86) PCT No.: PCT/JP2012/075197

§ 371 Date: Mar. 16, 2015

(51) Int. Cl. G09G 5/36; G07D 11/00; G09G 5/00

(52) U.S. Cl. CPC G09G 5/363; G09G 5/005; G07D 11/0036; G07D 11/009; G07D 11/0021; G09G 2380/00; G09G 2360/02

(57) ABSTRACT

The money handling system includes: a money handling apparatus 100, 200 configured to handle money; and an amount-of-money display unit 10 configured to display an amount of money handled by the money handling apparatus 100, 200. The money handling system also includes: a style setting unit 61 configured to set a display style for an amount point or a digit grouping separator, which is used when the amount of money is displayed on the amount-of-money display unit 10; a storage unit 62 configured to store the display style set by the style setting unit 61; and a control unit 65 configured to cause the amount-of-money display unit 10 to display the amount of money with the use of the display style stored in the storage unit 62.

### TECHNICAL FIELD

The present invention relates to a money handling system including an amount-of-money display unit configured to display an amount of money, a money handling apparatus, and a money handling method.

### BACKGROUND ART

Conventionally, there is known a money handling system including: a coin handling apparatus configured to execute a deposit process and/or a dispensing process of coins, a banknote handling apparatus configured to execute a deposit process and/or a dispensing process of banknotes, a point of sales (POS) register connected to the coin handling apparatus and the banknote handling apparatus (see JP 2011-54037, for example).

In general, the POS register of the above type of the money handling system has a POS screen. In addition, the money handling system may be provided with a customer screen, which is different from the POS screen. The customer screen is used for customer's confirmation of a total amount of money of purchase goods and/or an amount of change.

The mark “,” (comma) is often used as a digit grouping separator, in the amount of money displayed on the amount-of-money display unit such as a POS screen or a customer screen. In addition, an ancillary unit such as a cent, which is used abroad, is often displayed after the mark “•” (period). (In the specification of the present application, a mark such as “.” that represents an ancillary unit is referred to as an “amount point”.)

However, according to the actual conditions of transactions, the display style regarding a digit grouping separator and/or an amount point is different between the respective countries where the money handling system is used. On the other hand, as described above, the conventional money handling system uses only the mark “,” (comma) as the digit grouping separator and only the mark “.” (period) as the amount point. Therefore, the display style that has been used in the money handling system and the actual conditions of transactions are sometimes not consistent with each other.

Furthermore, at the 22th General Conference of Weights and Measures (CGPM: Conference General des Poides et Mesures) held in 2003, it was determined that the mark “.” (period) or the mark “,” (comma) is used as an amount point and a space is used as a digit grouping separator. The display style that has been used in the conventional money handling system is also not consistent with the determination.

### SUMMARY OF THE INVENTION

The present invention has been made in view of the above circumstances. The object of the present invention is to provide a money handling system, a money handling apparatus and a money handling method, which are capable of displaying an amount of money with the use of a digit grouping separator and an amount point according to the display style in consistence with the actual conditions of transactions or the determination by the 22th General Conference of Weights and Measures, by means of a suitable selection.

The money handling system according to the present invention includes: a money handling apparatus configured to handle money; an amount-of-money display unit configured to display an amount of money handled by the money handling apparatus; a style setting unit configured to set a display style for an amount point or a digit grouping separator, which is used when the amount of money is displayed on the amount-of-money display unit; a storage unit configured to store the display style set by the style setting unit; and a control unit configured to cause the amount-of-money display unit to display the amount of money with the use of the display style stored in the storage unit.

The money handling system according to the present invention may further include an outside apparatus different from the money handling apparatus, wherein the style setting unit is located in the outside apparatus, and the display style set by the style setting unit is stored in the storage unit via a communication unit.

In the money handling system according to the present invention, the money handling apparatus may be a money settlement apparatus configured to dispense money whose amount corresponds to a difference between an amount of deposit money and an amount of sales, and the amount-of-money display unit may be configured to display the amount of sales, the amount of deposit money, the amount of change corresponding to the difference between the amount of deposit money and the amount of sales.

In the money handling system according to the present invention, the style setting unit may be configured to further set a location of the digit grouping separator, and the storage unit may be configured to further store the location of the digit grouping separator set by the style setting unit.

In the money handling system according to the present invention, the display style for the digit grouping separator may be selectable from a group having at least two of a comma, a period, an apostrophe and a space, and one display style selected from the group can be selectively set as the display style for the digit grouping separator by means of the style setting unit.

In the money handling system according to the present invention, the display style for the amount point may be selectable from a comma and a period, and the comma or the period can be selectively set as the display style for the amount point by means of the style setting unit.

The money handling system according to the present invention may further include a currency setting unit configured to set a currency of money to be handled, wherein the display style set by the style setting unit is automatically determined depending on the currency set by the currency setting unit.

The money handling system according to the present invention may further include a country setting unit configured to set a country where the money handling system is to be used, wherein the display style set by the style setting unit is automatically determined depending on the country set by the country setting unit.

In the above money handling system, when the country set by the country setting unit is the United Kingdom or the United States of America, a comma may be set as the display style for the digit grouping separator, and a period may be set as the display style for the amount point.

In the above money handling system, when the country set by the country setting unit is France or the Republic of South Africa, a space may be set as the display style for the digit grouping separator, and a comma may be set as the display style for the amount point.

In the above money handling system, when the country set by the country setting unit is Germany, a period may be set as the display style for the digit grouping separator, and a comma may be set as the display style for the amount point.

In the above money handling system, when the country set by the country setting unit is India, a comma may be set as the display style for the digit grouping separator, a period may be set as the display style for the amount point, a location of the digit grouping separator may be set after each 2n digits (“n” is any integer more than one).

In the above money handling system, when the amount point is set by the style setting unit, the display style for the digit grouping separator different from the amount point may be automatically set, and/or when the digit grouping separator is set by the style setting unit, the display style for the amount point different from the digit grouping separator may be automatically set.

In the above money handling system, when a comma is set as the display style for the digit grouping separator by the style setting unit, a period may be automatically set as the display style for the amount point, and/or when a period is set as the display style for the amount point by the style setting unit, a comma may be automatically set as the display style for the digit grouping separator.

In the above money handling system, when a comma is set as the display style for the amount point by the style setting unit, a space or a period may be automatically set as the display style for the digit grouping separator, and/or when a space or a period is automatically set as the display style for the digit grouping separator by the style setting unit, a comma may be automatically set as the display style for the amount point.

In the above money handling system, when a period or a comma is set as the display style for the amount point by the style setting unit, a space may be automatically set as the display style for the digit grouping separator, and/or when a space is automatically set as the display style for the digit grouping separator by the style setting unit, a period or a comma may be automatically set as the display style for the amount point.

The money handling system according to the present invention may further include a currency setting unit configured to set a currency of money to be handled, wherein when no money of ancillary unit for the currency of money to be handled is in circulation, the control unit may cause the amount-of-money display unit not to display the amount point and figures after the amount point.

The money handling system according to the present invention may further include a country setting unit configured to set a country where the money handling system is to be used, wherein when no money of ancillary unit is in circulation in the country set by the country setting unit, the control unit may cause the amount-of-money display unit not to display the amount point and figures after the amount point.

A money handling apparatus according to the present invention includes: an amount-of-money display unit configured to display an amount of money handled by the money handling apparatus; a storage unit configured to store a display style for an amount point or a digit grouping separator, which is set by a style setting unit; and a control unit configured to cause the amount-of-money display unit to display the amount of money with the use of the display style stored in the storage unit.

A money handling method according to the present invention includes: setting a display style for an amount point or a digit grouping separator by means of a style setting unit; storing the display style set by the style setting unit in a storage unit; handling money by means of a money handling apparatus; and displaying on an amount-of-money display unit an amount of money with the display style stored in the storage unit, during the handling.

According to the present invention, there is provided the style setting unit configured to set the display style for the amount point or the digit grouping separator, which is used when the amount of money is displayed on the amount-of-money display unit, and the display style set by the style setting unit is stored in the storage unit. Subsequently, the control unit causes the amount-of-money display unit to display the amount of money with the use of the display style stored in the storage unit. Thus, according to the present invention, the amount of money can be displayed with the use of a digit grouping separator and an amount point according to the display style in consistence with the actual conditions of transactions or the determination by the 22th General Conference of Weights and Measures, by means of a suitable selection by the style setting unit.

### BRIEF DESCRIPTION OF THE DRAWINGS

FIG. 1 is a view showing a layout of a store provided with a money settlement apparatus according to a first embodiment of the present invention;

FIG. 2 is a schematic view showing a system structure of the store provided with the money settlement apparatus according to the first embodiment of the present invention;

FIG. 3 is a perspective view showing the money settlement apparatus according to the first embodiment of the present invention;

FIG. 4 is a schematic lateral sectional view showing an inside structure of a coin settlement apparatus according to the first embodiment of the present invention;

FIG. 5 is a schematic front sectional view showing the inside structure of the coin settlement apparatus according to the first embodiment of the present invention;

FIG. 6 is a schematic lateral sectional view showing an inside structure of a banknote settlement apparatus according to the first embodiment of the present invention;

FIG. 7 is a schematic view showing a connecting manner of the money handling system according to the first embodiment of the present invention;

FIG. 8 is a block view of the money handling system according to the first embodiment of the present invention;

FIG. 9 is a view showing an example of manner displayed on a display screen of a personal computer with a browser function, when a display style is selected in the first embodiment of the present invention;

FIG. 10 is a view showing an example of manner displayed on the display screen, when a settlement process is executed in the first embodiment of the present invention;

FIG. 11 is a view showing an example of manner displayed on the display screen, when an amount of cash in a banknote settlement apparatus used in the first embodiment of the present invention is confirmed;

FIG. 12 is a view showing an example of manner displayed on the display screen, when money is replenished from an inlet unit in the first embodiment of the present invention;

FIG. 13 is a view showing an example of manner displayed on the display screen, when banknotes are replenished from a banknote collection cassette in the first embodiment of the present invention;

FIG. 14 is a view showing an example of manner displayed on the display screen, when money is collected in the first embodiment of the present invention;

FIG. 15 is a schematic view showing a connecting manner of the money handling system according to a first modified example of the first embodiment of the present invention;

FIG. 16 is a schematic view showing a connecting manner of the money handling system according to a second modified example of the first embodiment of the present invention;

FIG. 17 is a schematic view showing a connecting manner of the money handling system according to a third modified example of the first embodiment of the present invention;

FIG. 18 is a block view of the money handling system according to the second embodiment of the present invention;

FIG. 19 is a block view of the money handling system according to the third embodiment of the present invention;

FIG. 20 is a view showing an example of manner displayed on a display screen of a personal computer with a browser function, when a display style is selected in the third embodiment of the present invention;

FIG. 21 is a view showing an example of manner displayed on the display screen, when a settlement process is executed in the third embodiment of the present invention;

FIG. 22 is a table showing display styles used in the embodiments of the present invention; and

FIG. 23 is a block view of a money handling system according to another embodiment different from the second and third embodiments of the present invention.

### MODE FOR CARRYING OUT THE INVENTION

### First Embodiment

### <Structure>

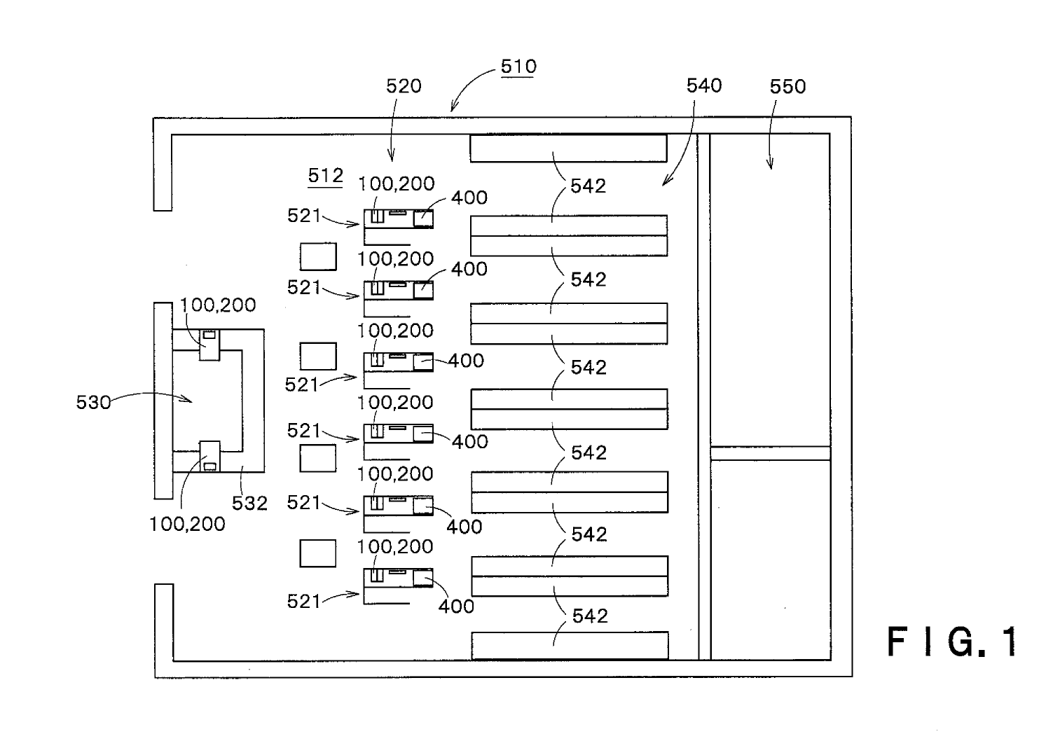

The first embodiment of a money handling apparatus, a money handling system and a money handling method according to the present invention will be explained herebelow with reference to the drawings. FIGS. 1 to 17 are views for explaining the first embodiment of the present invention. In the specification of the present application, “money” means both “coin” and “banknote”.

At first, a layout of a store provided with a money settlement apparatus (money handling apparatus) 100, 200 according to the first embodiment is explained with reference to FIG. 1.

In this embodiment, the money settlement apparatus 100, 200 is explained as a money handling apparatus. However, the present invention is not limited thereto. The money handling apparatus may be, for example, an apparatus provided with a drawer for handling money, as far as the money handling apparatus can handle money.

As shown in FIG. 1, the store 510 such as a supermarket is divided into a front area 512 where any customer is allowed to enter and a back office 550 where no customer is allowed to enter. The front area 512 consists of a settlement spot 520 in which a plurality of register systems 521 are provided, a customer service area 530, and a store shelf area 540 in which a plurality of store shelves 542 are provided for displaying commercial goods. After a customer has taken a commercial good from a store shelf 542 of the store shelf area 540, the customer executes a settlement process at the settlement spot 520 regarding the commercial good. Each register system 521 at the settlement spot 520 is provided with a POS (point of sale) register 400 and/or a money settlement apparatus 100, 200. In addition, the customer service area 530 is located near an entrance of the store 510. Another money settlement apparatus 100, 200 is located at the service counter 532 of the customer service area 530.

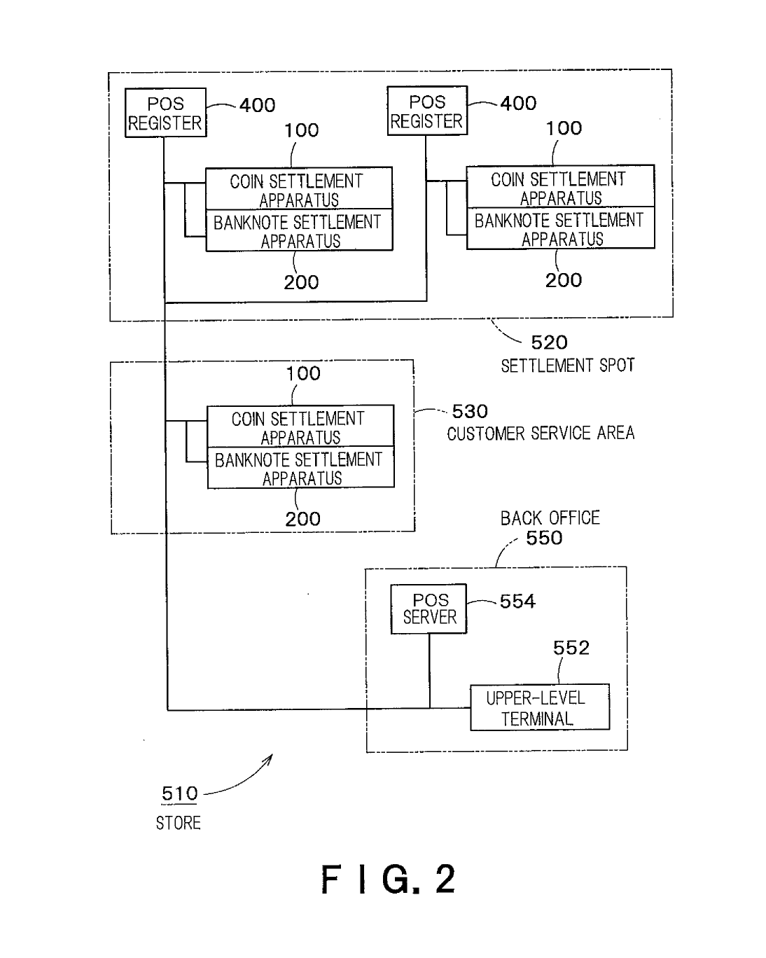

The structure of the store system of the store 510 shown in FIG. 1 is explained with reference to FIG. 2. As shown in FIG. 2, the back office 550 is provided with an upper-level terminal 552. The upper-level terminal 552 is communicatively connected to the POS register 400 and the money settlement apparatus 100, 200 at the settlement spot 520 as well as the money settlement apparatus 100, 200 at the customer service area 530. In addition, the back office 550 is provided with a POS server 554. The POS server 554 is communicatively connected to the upper-level terminal 552. The upper-level terminal 552 can transmit and receive various information to and from the POS server 554.

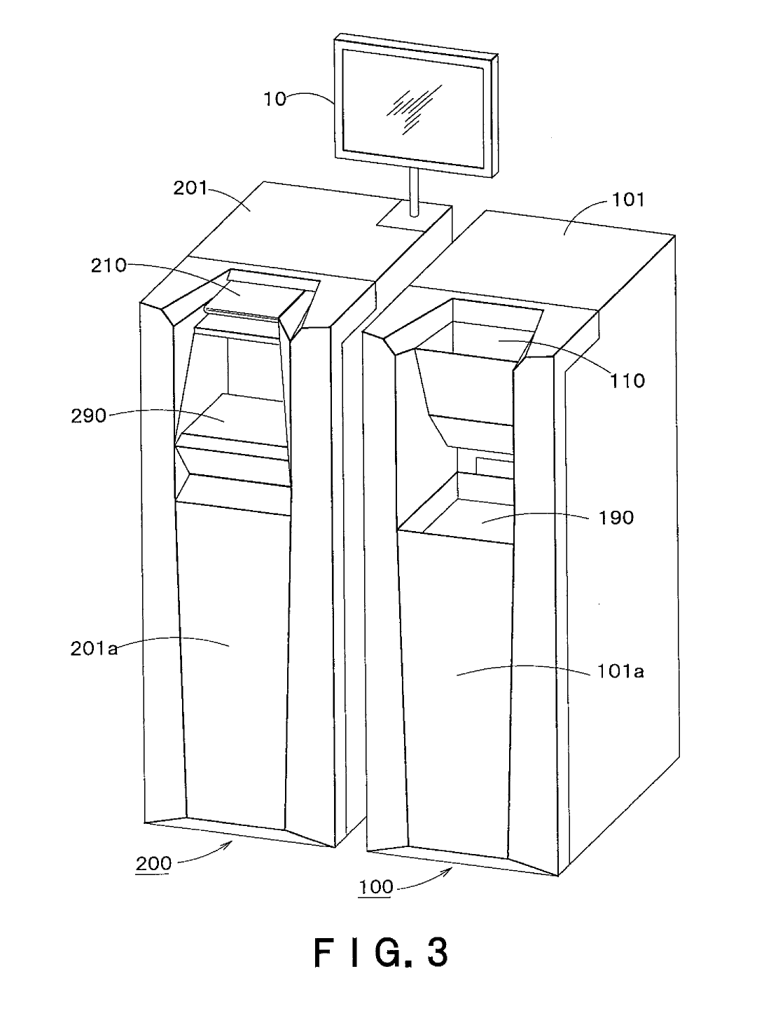

The money handling system of the present embodiment includes a display screen (an amount-of-money display unit) 10 configured to display an amount of money handled by the money handling apparatus 100, 200, as shown in FIG. 3. The money handling apparatus 100, 200 used in the present embodiment dispenses money whose amount corresponds to a difference between an amount of deposit money and an amount of sales. The display screen 10 is configured to display the amount of sales, the amount of deposit money, the amount of change corresponding to the difference between the amount of deposit money and the amount of sales. In the present embodiment, the display screen 10 is explained as an amount-of-money display unit. However, the present invention is not limited thereto. The amount-of-money display unit may be a display screen provided on the POS register 400 or a display screen provided on the money handling apparatus 100, 200.

The money settlement apparatus 100, 200 of the present embodiment includes a coin settlement apparatus 100 that executes a settlement process regarding one or more coins, and a banknote settlement apparatus 200 that executes a settlement process regarding one or more banknotes. In the present embodiment, the money handling apparatus includes both the coin handling apparatus that handles coins and the banknote handling apparatus that handles banknotes. However, the present invention is not limited thereto. The money handling apparatus may be a coin handling apparatus that handles only coins or a banknote handling apparatus that handles only banknotes.

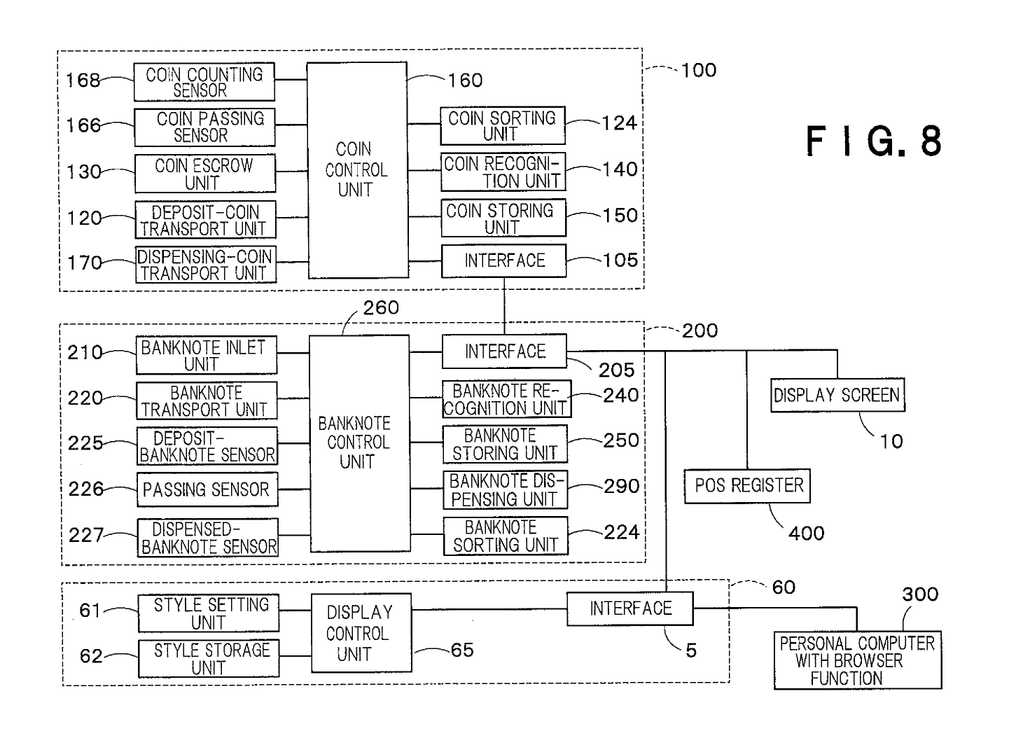

The display screen 10 is configured to display an amount of money based on information received from the POS register 400, the coin settlement apparatus 100 and the banknote settlement apparatus 200. The display screen 10 is connected to the banknote settlement apparatus 200 directly, and to the coin settlement apparatus 100 and the POS register 400 through the banknote settlement apparatus 200 (see FIG. 8).

### <Coin Settlement Apparatus 100>

Next, the structure of the coin settlement apparatus 100 is explained.

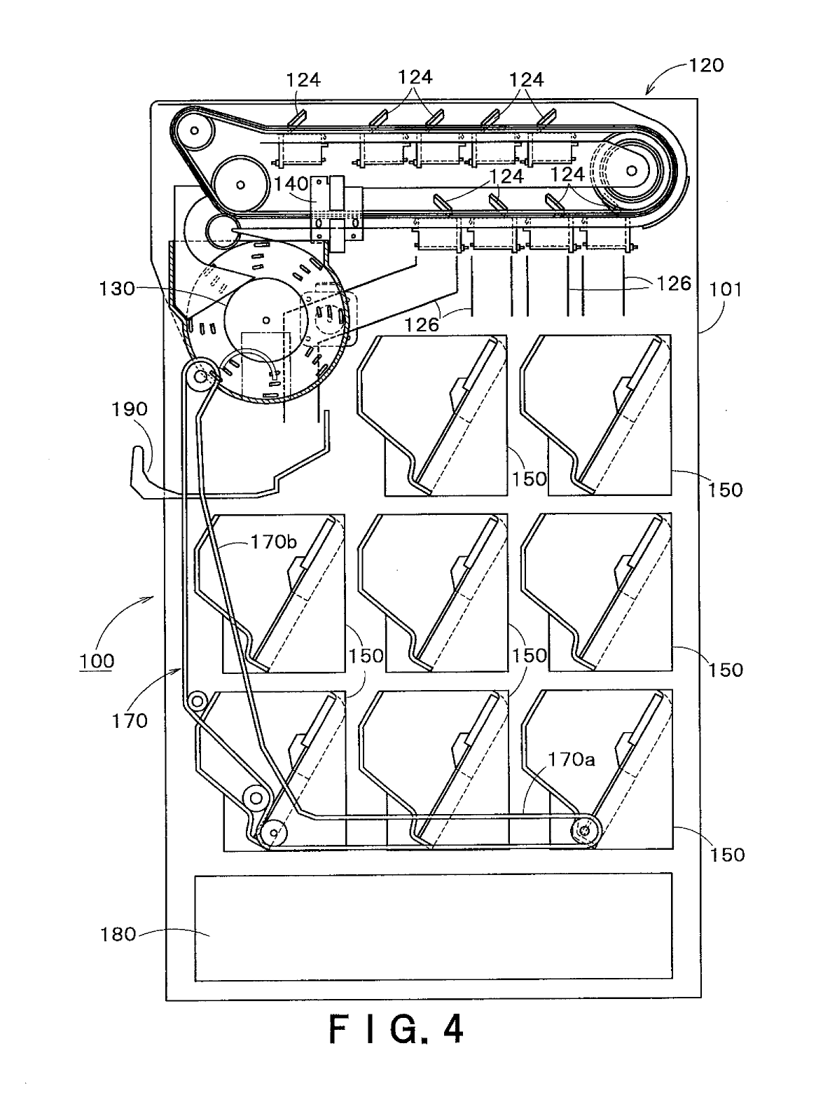

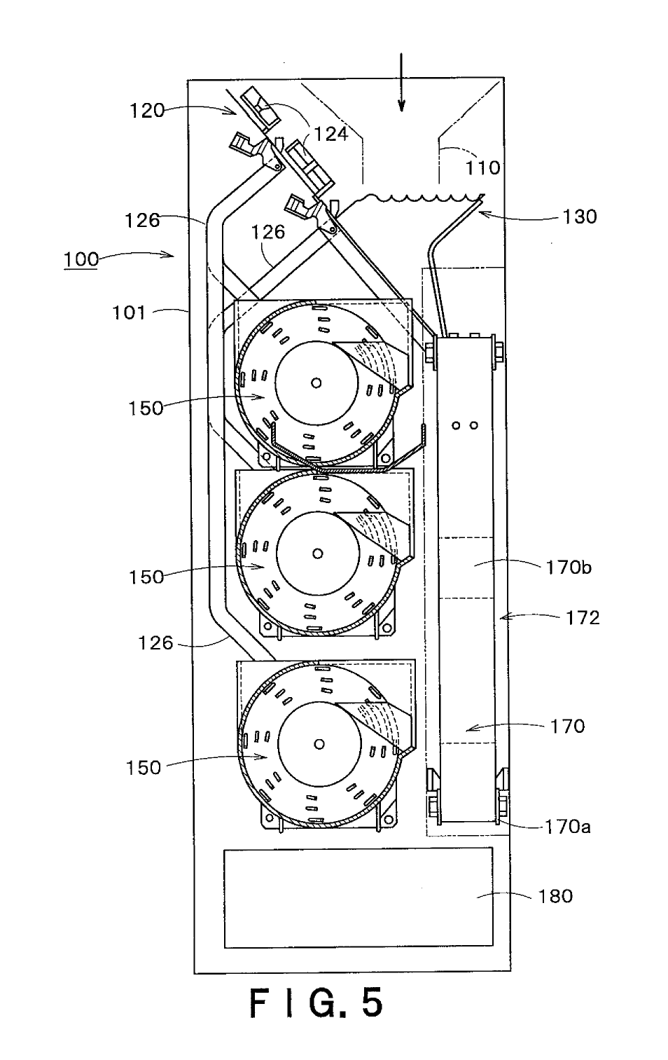

As shown in FIG. 4, the coin settlement apparatus 100 includes: a substantially cuboid coin housing 101; a coin inlet unit 110 provided on the coin housing 101 for inputting coins (see FIG. 5); and a coin escrow unit 130 configured to reserve coins transported from the coin inlet unit 110 and feed out the reserved coins one by one. In addition, in the coin housing 101, there is a deposit-coin transport unit 120 configured to transport the coins fed out by the escrow unit 130. A coin recognition unit 140 is disposed on the deposit-coin transport unit 120, the recognition unit 140 configured to recognize each coin transported by the deposit-coin transport unit 120 and to count the coins for each denomination. The coin recognition unit 140 is configured to recognize denomination, authenticity, fitness and so on for each coin, and count the coins for each denomination. The coin inlet unit 110 is located at an upper portion of the coin housing 101. The coins inputted from the coin inlet unit 110 are transported to the escrow unit 130 by their own weight, and temporarily reserved in the escrow unit 130 (see FIG. 5).

In addition, a plurality of (eight, in the present embodiment) coin storing units 150 is provided below the deposit-coin transport unit 120 in the coin housing 101. Based on the recognition result of each coin by the coin recognition unit 140, the coins transported from the deposit-coin transport unit 120 are sorted by coin sorting units 124 provided on the deposit-coin transport unit 120, and stored in the respective coin storing units 150. In addition, each coin storing unit 150 is configured to feed out the coins stored therein, one by one, when needed.

In addition, the coin settlement apparatus 100 includes a coin dispensing unit 190 configured to dispense one or more coins outside the coin housing 101. There is provided a dispensing-coin transport unit 170 configured to transport the coins fed out from the respective coin storing units 150 to the coin dispensing unit 190. There is also provided a coin collection box 180 below the dispensing-coin transport unit 170 in the coin housing 101. Furthermore, there is provided a detection sensor (not shown) configured to detect as to whether the coins are taken out or not, at the coin dispensing unit 190.

In the present embodiment, nine coin sorting units 124 are provided on the deposit-coin transport unit 120. One coin sorting unit 124 among them is configured to function as a reject coin sorting unit. When a coin is judged as a reject coin based on the recognition result by the coin recognition unit 140, the coin is sorted by the reject coin sorting unit, and transported to the coin dispensing unit 190. Each coin sorting unit 124 is provided with a corresponding chute 126. The coin sorted by each coin sorting unit 124 is transported to the coin dispensing unit 190 or the corresponding coin storing unit 150, through the corresponding chute 126 provided at the coin sorting unit 124.

The dispensing-coin transport unit 170 of the present embodiment includes a first dispensing-coin transport part 170a extending in a substantially horizontal direction below the respective coin storing units 150 and a second dispensing-coin transport part 170b for transporting one or more coins transported from the first dispensing-coin transport part 170a to the coin dispensing unit 190.

The dispensing-coin transport unit 170 has an endless belt provided with a plurality of projection members (not shown). One or more coins are picked up by one projection member, so that the one or more coins are transported. In addition, as shown in FIG. 5, a coin dispensing space 172 is formed on one lateral side (right side in FIG. 5) of each coin storing unit 150. In the coin dispensing space 172, each coin fed out from the coin storing units 150 falls down on the endless belt at the first dispensing-coin transport part 170a of the dispensing-coin transport unit 170. The above described chute 126 is provided on the other lateral side (left side in FIG. 5) of each coin storing unit 150.

A coin passing sensor 166 and a pair of coin counting sensors 168 are provided at a coin outlet opening at each coin storing unit 150 (see FIG. 8). The coin passing sensor 166 is configured to detect that a coin transported to the coin outlet opening of the coin storing unit 150 passes through the coin passing sensor 166. The pair of coin counting sensors 168 is configured to count coins fed out from the coin outlet opening of the coin storing unit 150.

When the endless belt is circulated in an anticlockwise direction in FIG. 4, a coin fed out from each coin storing unit 150 passes through the coin dispensing space 172 by its own weight, and falls down on the endless belt at the first dispensing-coin transport part 170a. Subsequently, the coin on the endless belt is transported from the first dispensing-coin transport part 170a to the second dispensing-coin transport part 170b. Then, the coin picked up by the projection member of the endless belt at the second dispensing-coin transport part 170b is transported upward in FIG. 4, finally to the coin dispensing unit 190 through an upper end portion of the second dispensing-coin transport part 170b.

On the other hand, when the endless belt is circulated in a clockwise direction in FIG. 4, a coin fed out from each coin storing unit 150 passes through the coin dispensing space 172 by its own weight, and falls down on the endless belt at the first dispensing-coin transport part 170a. However, subsequently, the coin on the endless belt is transported from the first dispensing-coin transport part 170a to the coin collection box 180, and finally stored in the coin collection box 180.

The coin collection box 180 is provided in a removable manner with respect to the coin housing 101. After the coins are stored in the coin collection box 180, the operator can remove the coin collection box 180 from the coin housing 101, so that the operator can collect the coins together with the coin collection box 180.

In addition, as shown in FIG. 3, a coin housing front cover 101a is provided on a front side of the coin housing 101 in an openable and closable manner. When the coin housing front cover 101a is opened, the coin collection box 180 can be removed from the coin housing 101, for example.

In addition, as shown in FIG. 8, the coin settlement apparatus 100 has a coin control unit 160 configured to control the coin settlement apparatus 100. The coin control unit 160 is connected to the above described components, i.e., the coin passing sensor 166, the pair of coin counting sensors 168, the coin escrow unit 130, the deposit-coin transport unit 120, the coin recognition unit 140, the coin sorting units 124, the coin storing units 150, the dispensing-coin transport unit 170, and so on. The coin control unit 160 is configured to send information or instruction commands to these components, and/or receive information or instruction commands from these components.

The coin control unit 160 consists of an IC chip, for example. The coin control unit 160 may consist of a plurality of IC chips, or only one ID chip. When the coin control unit 160 consists of a plurality of IC chips, it is not necessary to locate the IC chips at the same place, and the respective IC chips may be located at different places.

### <Banknote Settlement Apparatus 200>

Next, the structure of the banknote settlement apparatus 200 is explained.

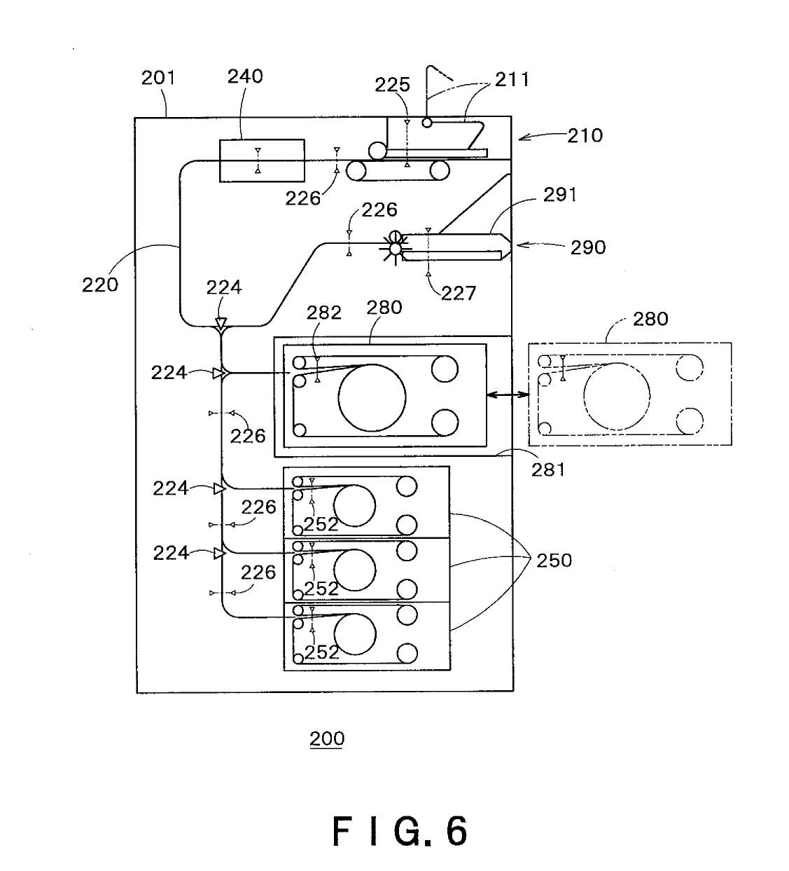

As shown in FIG. 6, the banknote settlement apparatus 200 includes: a substantially cuboid banknote housing 201; a banknote inlet unit 210 provided on the banknote housing 101 for inputting banknotes; a banknote transport unit 220 configured to transport banknotes deposited from the banknote inlet unit 210 one by one; a banknote recognition unit 240 configured to recognize denomination, authenticity, fitness and so on for each banknote transported by the banknote transport unit 220, and to count the banknotes for each denomination; a plurality of (three, in the present embodiment) banknote storing units 250 configured to store the banknotes based on the recognition result of each banknote by the banknote recognition unit 240. Each banknote storing unit 250 is configured to feed out the banknotes stored therein, one by one, when needed.

In addition, the banknote settlement apparatus 200 includes a banknote dispensing unit 290 configured to dispense one or more banknotes fed out from the banknote storing units 250 to the banknote transport unit 220. Not only the banknotes fed out from the banknote storing units 250 but also a reject banknote, which is rejected by a reason such that the banknote could not be recognized by the banknote recognition unit 240, is transported to the banknote dispensing unit 290. In addition, banknote sorting units 224 are provided on the banknote transport unit 220, each banknote sorting unit configured to suitably sort the transported banknotes based on the recognition result of each banknote by the banknote recognition unit 240. A plurality of passing sensors 226 each configured to detect that a banknote passes through the passing sensor 226 is provided at the banknote transport unit 220. In addition, there is provided a banknote-storing-unit sensor 252 configured to detect as to whether the banknotes are put in or taken out, at the banknote storing unit 250.

In addition, a banknote-collection-cassette mounting unit 281, which is open on a front side thereof, is provided on the banknote housing 201. A banknote collection cassette can be mounted on the banknote-collection-cassette mounting unit 281 in a removable manner. The banknote transport unit 220 extends up to the banknote-collection-cassette mounting unit 281, so that the banknote transport unit 220 can transport the banknotes to the banknote collection cassette 280. There is provided a banknote-collection-cassette sensor 282 configured to detect as to whether the banknotes are put into or taken out from the banknote collection cassette 280, at the banknote collection cassette 280.

A deposit-banknote sensor 225 is provided at the banknote inlet unit 210 for detecting as to whether the one or more banknotes are left at the banknote inlet unit 210. A dispensed-banknote sensor 227 is provided at the banknote dispensing unit 290 for detecting as to whether the one or more banknotes are left at the banknote dispensing unit 290.

The banknote inlet unit 210 includes a banknote-inlet-unit cover 211 for covering the banknote inlet unit 210. The banknote dispensing unit 290 includes a banknote-dispensing-unit cover 291 for covering the banknote dispensing unit 290. In addition, as shown in FIG. 3, a banknote housing front cover 201a is provided on a front side of the banknote housing 201 in an openable and closable manner. When the banknote housing front cover 201a is opened, the banknote collection cassette 280 can be mounted on or removed from the banknote-collection-cassette mounting unit 281.

In addition, as shown in FIG. 8, the banknote settlement apparatus 200 has a banknote control unit 260 configured to control the banknote settlement apparatus 200. The banknote control unit 260 is connected to the above described components, i.e., the banknote inlet unit 210, the banknote transport unit 220, the banknote sorting units 224, the deposit-banknote sensor 225, the passing sensor 226, the dispensed-banknote sensor 227, the banknote recognition unit 240, the banknote storing units 250, the banknote dispensing unit 290, and so on. The banknote control unit 260 is configured to send information or instruction commands to these components, and/or receive information or instruction commands from these components. In addition, although it is not shown, the banknote control unit 260 is connected to the banknote-storing-unit sensor 252 and the banknote-collection-cassette sensor 282, so that the banknote control unit 260 is also configured to receive information from the banknote-storing-unit sensor 252 and the banknote-collection-cassette sensor 282.

The banknote control unit 260 consists of an IC chip, for example. The banknote control unit 260 may consist of a plurality of IC chips, or only one ID chip. When the banknote control unit 260 consists of a plurality of IC chips, it is not necessary to locate the IC chips at the same place, and the respective IC chips may be located at different places.

### <Selection of Display Style>

Next, a selection of a display style for an amount point and a digit grouping separator, which may be used when an amount of money is displayed on a display screen, is explained. In the present embodiment, the display style for both the amount point and the digit grouping separator can be selected. However, the present invention is not limited thereto. Only a display style for an amount point may be selected, or only a display style for a digit grouping separator may be selected.

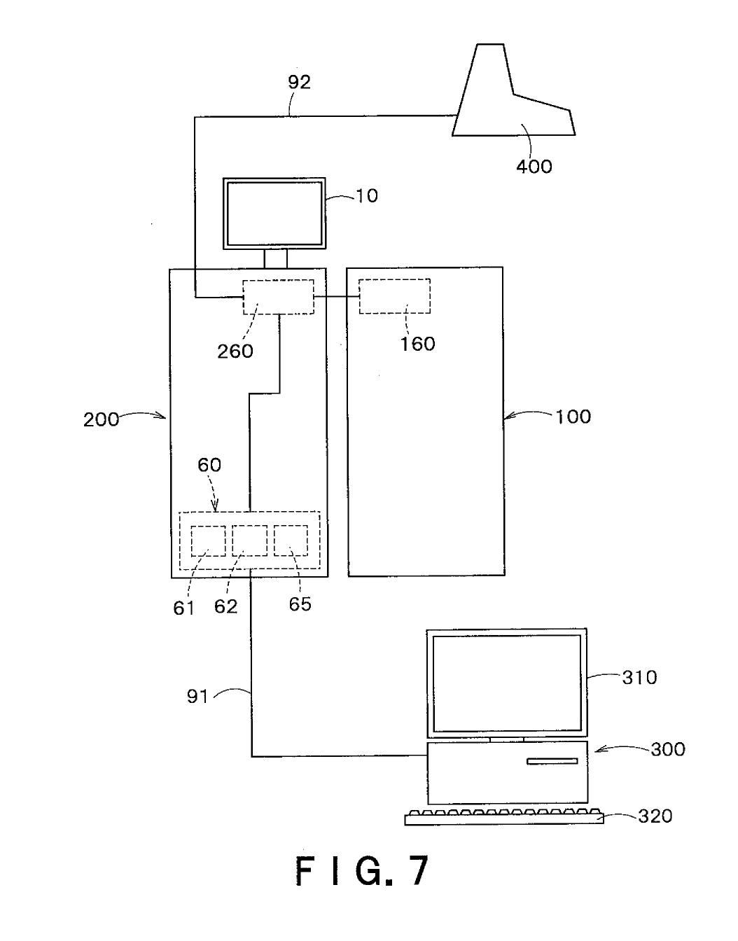

As shown in FIG. 7, the money settlement system according to the present embodiment includes: a style setting unit 61 configured to select and set a display style for an amount point and a digit grouping separator, which is used when an amount of money is displayed on the display screen 10; a style storage unit (storage unit) 62 configured to store the display style set by the style setting unit 61; and a display control unit (control unit) 65 configured to cause the display screen 10 to display the amount of money with the use of the display style stored in the storage unit 62. Specifically, a BOX personal computer 60 is provided in the banknote housing 201 of the banknote settlement apparatus 200, and the BOX personal computer 60 includes the style setting unit 61, the style storage unit 62 and the display control unit 65.

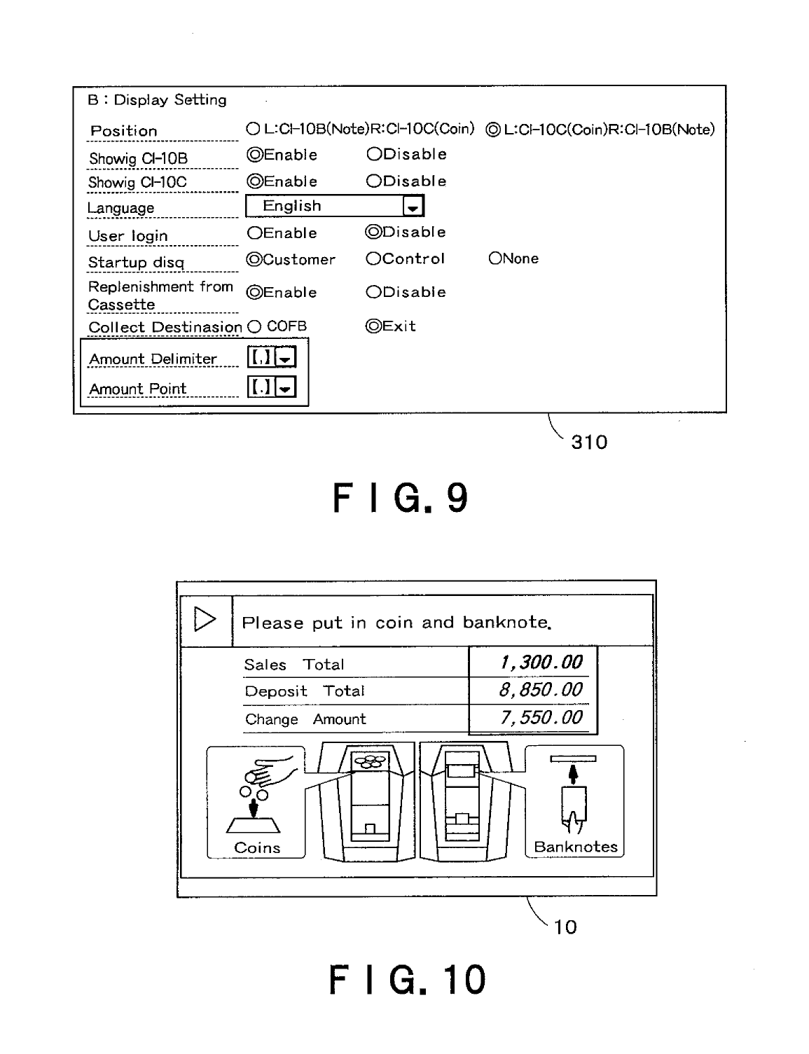

The style setting unit 61 is communicatively connected to a personal computer with a browser function 300, through communication means 91 such as a LAN or an Internet connection. In addition, the banknote control unit 260 is communicatively connected to the POS register 400, through communication means 92 such as a LAN or an Internet connection. An operator can see the display style set by the style setting unit 61 by means of a display screen 310 of the personal computer with a browser function 300 (a remote display is possible). Then, the display style can be changed by operating a keyboard 320, a mouse or the like, of the personal computer with a browser function 300. In a manner shown in FIG. 9, as shown by a rectangular frame, a display style for an amount point (“Amount Point” in FIG. 9) can be selected by means of a pulldown menu selection screen, and a display style for a digit grouping separator (“Amount Delimiter” in FIG. 9) can be selected by means of another pulldown menu selection screen. Herein, in the present embodiment, the size of each figure after the amount point (each figure on the right side of the amount point) is the same as the size of each figure before the amount point (each figure on the left side of the amount point). However, the size of each figure after the amount point may be displayed smaller than the size of each figure before the amount point.

The style setting unit 61 of the present embodiment can set a location of the digit grouping separator. The style storage unit 62 can store the location of the digit grouping separator set by the style setting unit 61.

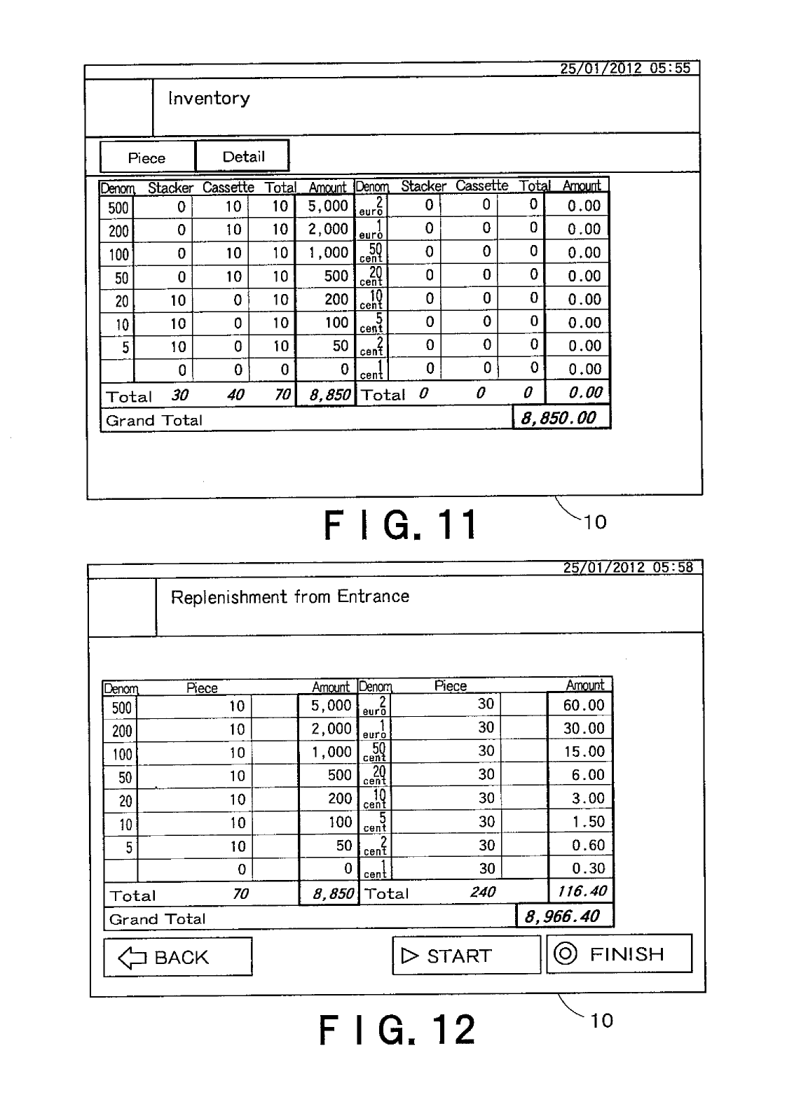

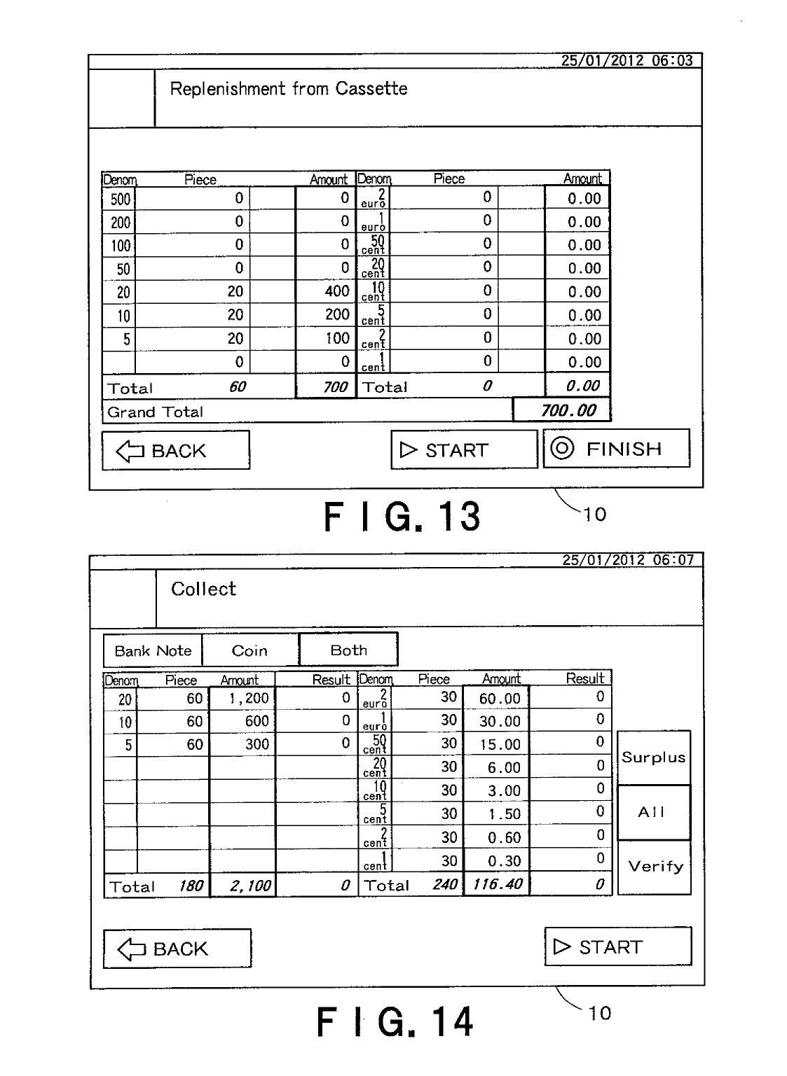

As described above, after the display style for the amount point and the digit grouping separator, and the location of the digit grouping separator are set by the style setting unit 61, the display style of the display screen 10 complies with the set ones in various situations. For example, when a settlement process is executed as shown in FIG. 10; when an amount of cash in the banknote settlement apparatus 200 is confirmed as shown in FIG. 11; when money is replenished from the inlet units 110, 210 as shown in FIG. 12; when banknotes are replenished from the banknote collection cassette 280 as shown in FIG. 13; and/or when money is collected by the coin collection box 180 and/or the banknote collection cassette 280; the display style for the amount point and the digit grouping separator on the display screen 10 complies with the display style that has been set by the style setting unit 61, and the location of the digit grouping separator on the display screen 10 complies with the location of the digit grouping separator that has been set by the style setting unit 61. In addition, the style setting unit 61 of the present embodiment may set a location of the amount point. In this case, the style storage unit 62 may store the location of the amount point set by the style setting unit 61 as well.

As shown in FIG. 8, the display control unit 65 is connected to the personal computer with a browser function 300 via an interface 5. The display control unit 65 is also connected to the banknote control unit 260 via the interfaces 5, 205. The banknote control unit 260 is connected to the display screen 10 and the POS register 400 via the interface 205. The banknote control unit 260 is connected to the coin control unit 160 via the interfaces 205, 105. Each of the display screen 10, the personal computer with a browser function 300 and the POS register 400 is also provided with an interface, which is not shown.

The display style for the digit grouping separator according to the present embodiment is selectable from a group including a comma, a period, an apostrophe and a space. One display style selected from the group can be selectively set as the display style for the digit grouping separator by means of the style setting unit 61.

The above manner wherein the display style for the digit grouping separator is selectable from the group including a comma, a period, an apostrophe and a space is just one example. For example, the display style for the digit grouping separator may be selectable from a group including two of a comma, a period, an apostrophe and a space. Specifically, the display style for the digit grouping separator may be selectable from a group having a comma, a period and an apostrophe; a group having a comma, a period and a space; a group having a period, an apostrophe and a space; a group having a comma and a period; a group having a comma and an apostrophe; a group having a comma and a space; a group having a period and an apostrophe; a group having a period and a space; or a group having an apostrophe and a space.

The display style for the amount point according to the present embodiment is selectable from a comma and a period. One display style selected from the comma or the period can be selectively set as the display style for the amount point by means of the style setting unit 61. Alternatively, the mark “•” may be set as the display style for the amount point.

In the United Kingdom, the United States of America and India, general is the display style wherein the digit grouping separator consists of a comma and the amount point consists of a period. Herein, in the United Kingdom or the United States of America, the mark “•” may be used as the display style for the amount point. In France and the Republic of South Africa, general is the display style wherein the digit grouping separator consists of a space and the amount point consists of a comma. In Germany, general is the display style wherein the digit grouping separator consists of a period and the amount point consists of a comma. As described above, at the 22th General Conference of Weights and Measures, it has been determined that a period or a comma is used as the amount point and a space is used as the digit grouping separator.

### <Operation and Effects>

Next, an operation and effects of the present embodiment structured as described above is explained.

According to the present embodiment, there is provided the style setting unit 61 configured to set the display style for the amount point or the digit grouping separator, which is used when an amount of money is displayed on the display screen 10, and the display style set by the style setting unit 61 is stored in the style storage unit 62. Subsequently, the display control unit 65 causes the display screen 10 to display the amount of money with the use of the display style stored in the style storage unit 62. Thus, according to the present embodiment, the amount of money can be displayed with the use of a digit grouping separator and an amount point according to the display style in consistence with the actual conditions of transactions or the determination by the 22th General Conference of Weights and Measures, by means of a suitable selection by the style setting unit 61.

The above point is explained hereinafter.

Conventionally, it was often the case that a comma is used as a digit grouping separator and a period is used as an amount point, and also this display style was fixed. However, according to the actual conditions of transactions, the display style regarding a digit grouping separator and/or an amount point is different between the respective countries where the money handling system is used. On the other hand, as described above, the conventional money handling system uses only the comma as the digit grouping separator and only the period as the amount point. Therefore, the display style that has been used in the money handling system and the actual conditions of transactions are sometimes not consistent with each other. Furthermore, at the 22th General Conference of Weights and Measures held in 2003, it was determined that a period or a comma is used as an amount point and a space is used as a digit grouping separator. The display style that has been used in the conventional money handling system is also not consistent with the determination.

In contrast, according to the present embodiment, a display style for an amount point and a digit grouping separator can be selected and set by the style setting unit 61. Thereafter, the amount of money can be displayed on the display screen 10 with the use of the thus set display style, so that the amount of money can be displayed with the use of a digit grouping separator and an amount point according to the display style in consistence with the actual conditions of transactions. Alternatively, the amount of money can be displayed with the use of a digit grouping separator and an amount point according to the display style in consistence with the determination by the 22th General Conference of Weights and Measures.

Herein, in the money handling apparatus including the money settlement apparatuses 100, 200 like the present embodiment, the possibility of changing the display style for an amount point or a digit grouping separator is a great advantage.

In the money settlement apparatus 100, 200, it is required to execute a large number of processes. Thus, it is very important that the amount point and the digit grouping separator are in consistence with familiar ones. That is to say, if the amount point and the digit grouping separator are familiar to a user such as a customer or a store clerk at a store, the customer or the store clerk can recognize the displayed amount of money in a very quick way, which improves the efficiency of the settlement process. However, if the amount point and the digit grouping separator that are not familiar to the user are used, the efficiency of the settlement process by the user becomes low.

This tendency is remarkable in a full-self or half-self case, in which a customer as a purchaser of a commercial good executes the settlement process by herself. When the purchaser of the commercial good executes the settlement process by herself (see FIG. 10), the purchaser is not accustomed to executing the settlement process. Thus, if the amount point and/or the digit grouping separator that are not familiar to the purchaser are displayed on the display screen 10, a longer time is needed for the purchaser's judgment as to how much the purchaser should pay, which deteriorates the efficiency of the settlement process. Such deterioration of the efficiency of the settlement process is disadvantageous not only for the customer but also the store wherein the money settlement apparatus 100, 200 is installed, because this decreases a turnover.

Thus, if the money settlement apparatus 100, 200 like the present embodiment is introduced in a store wherein a customer as a purchaser of a commercial good executes the settlement process by herself, such as in a full-self or half-self manner, deterioration of the efficiency of the settlement process can be significantly prevented, which is very advantageous.

In addition, in the present embodiment, the money handling apparatus consists of a money settlement apparatus 100, 200 configured to dispense money whose amount corresponds to a difference between an amount of deposit money and an amount of sales, and the display screen 10 can display the amount of sales, the amount of deposit money, and the amount of change, respectively, with the use of the display style that has been set by the style setting unit 61.

In addition, in the present embodiment, the style setting unit 61 can set a location of the digit grouping separator. The location of the digit grouping separator may be set after any number of digits, not limited to three digits. For example, when the money settlement apparatus 100, 200 is used in India, the location of the digit grouping separator may be set after each 2n digits (“n” is any integer more than one), such as four digits, six digits, eight digits, and the like. Then, the amount of money can be displayed with the use of the digit grouping separator in consistence with the actual conditions of transactions.

In addition, in the present embodiment, the display style for the digit grouping separator can be selected from the group including the comma, the period, the apostrophe and the space. That is to say, the display style for the digit grouping separator can be selected from a relatively large number of options. Therefore, with a higher probability, the amount of money can be displayed on the display screen 10 with the use of the display style for the digit grouping separator that is usually used in a country where the money settlement apparatus 100, 200 is installed.

In addition, in the present embodiment, the display style for the amount point can be selected from the comma or the period. That is to say, the display style for the amount point can be selected from the comma or the period that are generally often used as an amount point. Therefore, with a higher probability, the amount of money can be displayed on the display screen 10 with the use of the display style for the amount point that is usually used in a country where the money settlement apparatus 100, 200 is installed.

Next, explained are the steps until the amount of money is displayed on the display screen 10 with the use of the display style stored in the style storage unit 62.

At first, the display style for the amount point and the digit grouping separator is selected and set by the style setting unit 61. At this time, the location of the digit grouping separator and the location of the amount point may be set as well. Hereafter, it is assumed that the location of the digit grouping separator and the location of the amount point have been set.

After the display style for the amount point and the digit grouping separator has been selected and set by the style setting unit 61, the set display style is stored in the style storage unit 62. The location of the digit grouping separator and the location of the amount point are also stored in the style storage unit 62.

After the display style for the amount point and the digit grouping separator as well as the locations of the digit grouping separator and of the amount point have been stored in the style storage unit 62, when money is handled at the money settlement apparatus 100, 200, an amount of money is displayed on the display screen 10 with the use of the display style for the amount point and the digit grouping separator as well as the locations of the digit grouping separator and of the amount point stored in the style storage unit 62 (see FIGS. 10 to 14).

### Modified Example 1

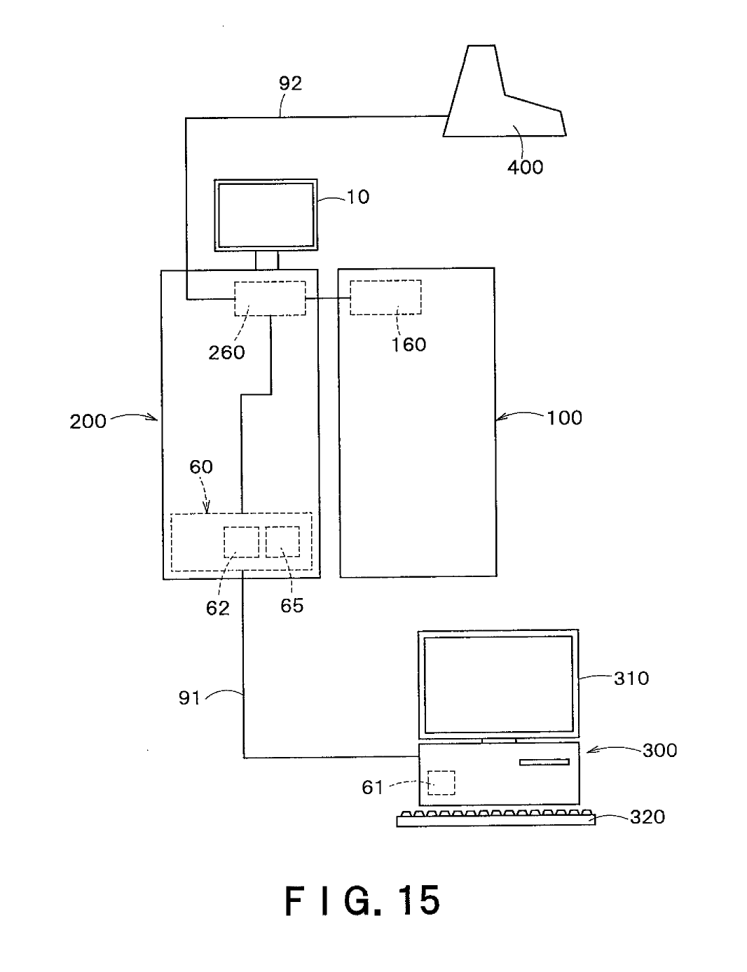

In the above embodiment, the money settlement apparatus 100, 200 (specifically, the banknote settlement apparatus 200) includes the style setting unit 61 configured to select and set the display style for the amount point and the digit grouping separator to be used when an amount of money is displayed on the display screen 10. However, the present invention is not limited thereto. For example, an outside apparatus such as a personal computer, which is different from the money settlement apparatus 100, 200, may include the style setting unit 61, and the display style that has been set by the style setting unit 61 may be stored in the style storage unit 62 via a communication unit such as an internet connection. As one of the modified example 1, as shown in FIG. 15, the personal computer with a browser function 300 includes the style setting unit 61.

### Modified Example 2

In addition, for example, an outside apparatus, which is different from the money settlement apparatus 100, 200, may include the style storage unit 62, and the display style that has been set by the style setting unit 61 may be stored in the style storage unit 62 via a communication unit such as a LAN or an internet connection.

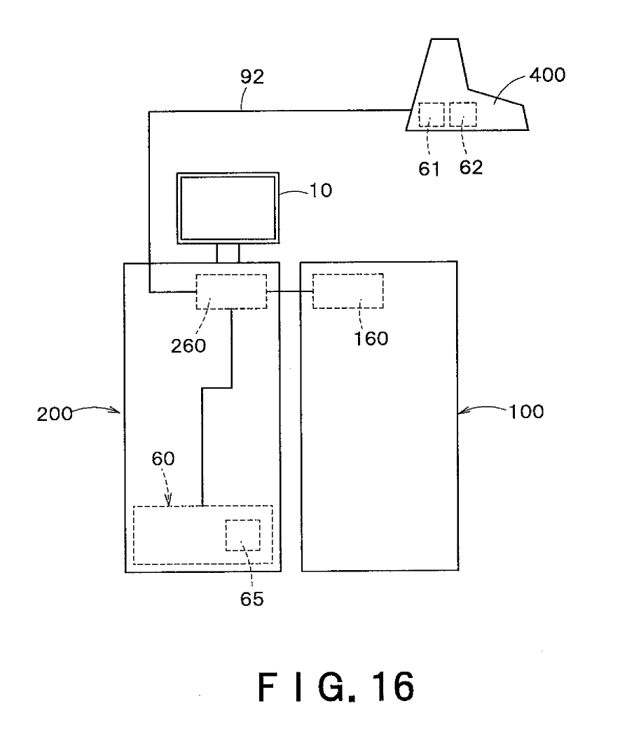

In the present modified example, the style storage unit 62 may be provided in the money settlement apparatus 100, 200, or in the outside apparatus as explained in the modified example 1. When the style storage unit 62 is provided in the outside apparatus, the outside apparatus including the style setting unit 61 and the outside apparatus including the style storage unit 62 may be the same, or different from each other. As one of the modified example 2, as shown in FIG. 16, the POS register 400 includes the style setting unit 61 and the style storage unit 62.

### Modified Example 3

In addition, for example, an outside apparatus, which is different from the money settlement apparatus 100, 200, may include the display control unit 65, and the display control unit 65 may cause the display screen 10 to display the amount of money with the use of the display style stored in the style storage unit 62.

In the present modified example, the style setting unit 61 may be provided in the money settlement apparatus 100, 200, or in the outside apparatus as explained in the modified example 1. Similarly, the style storage unit 62 may be provided in the money settlement apparatus 100, 200, or in the outside apparatus as explained in the modified example 2.

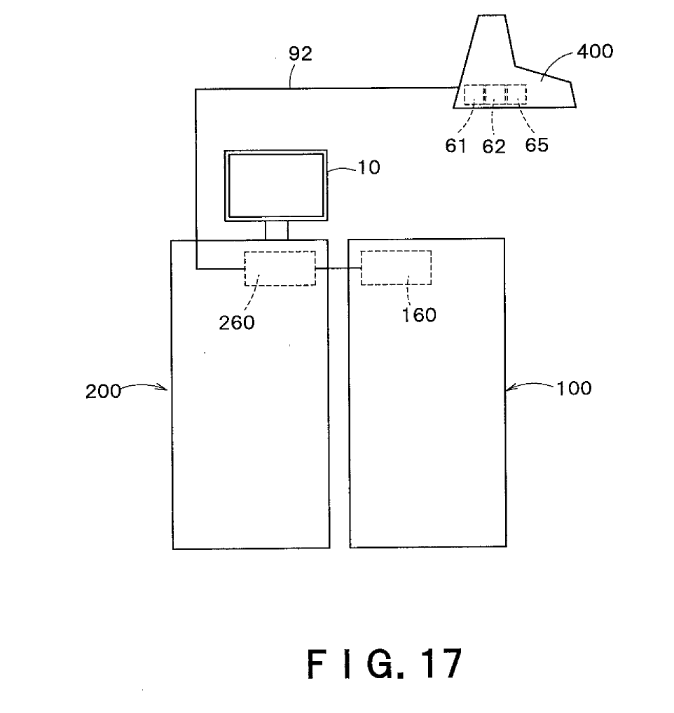

Herein, when the style storage unit 62 is provided in the outside apparatus and/or when the style setting unit 61 is provided in the outside apparatus, the outside apparatus including the style storage unit 62, the outside apparatus including the style setting unit 61 and the outside apparatus including the display control unit 65 may be the same, or different from each other. One outside apparatus may include two of the style storage unit 62, the style setting unit 61 and the display control unit 65, and another outside apparatus may include the other one. As one of the modified example 3, as shown in FIG. 17, the POS register 400 includes the style setting unit 61, the style storage unit 62 and the display control unit 65.

Any one of the above modified examples can achieve the same effects as those of the above embodiment.

### Second Embodiment

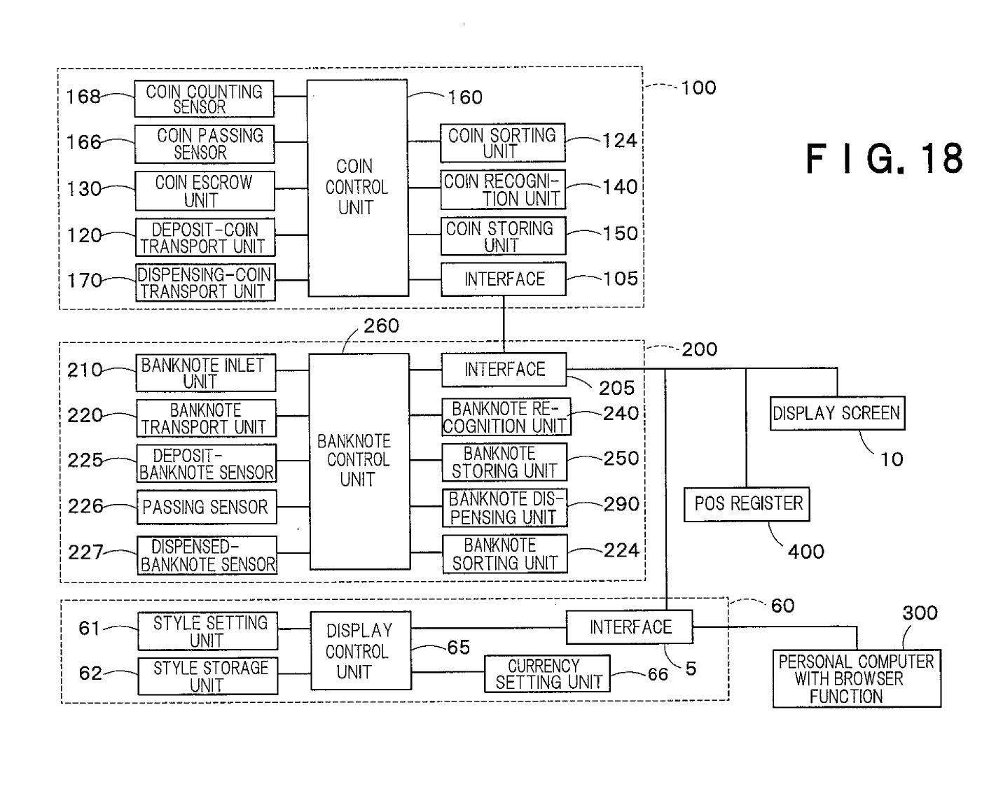

Next, mainly with reference to FIG. 18, a second embodiment of the present invention is explained.

In addition to the matters explained in the first embodiment, according to the second embodiment, provided is a currency setting unit 66 configured to set a currency of money to be handled. Then, the display style set by the style setting unit 61 is automatically determined depending on the currency set by the currency setting unit 66. In the present embodiment, a BOX personal computer 60 has the currency setting unit 66. However, the present invention is not limited thereto. An outside apparatus different from the money settlement apparatus 100, 200 may have the currency setting unit 66.

In addition, according the present embodiment, when no money of ancillary unit for the currency of money to be handled is in circulation, the display control unit 65 causes the display screen 10 not to display the amount point and figures after the amount point.

The other structure of the second embodiment is substantially the same as that of the first embodiment. In the second embodiment, the same parts as the first embodiment are shown by the same reference numerals, and detailed explanation thereof is omitted.

According to the second embodiment as well, the same effects as the first embodiment can be achieved. Unique portions of the effects of the second embodiments are explained hereafter since the same effects have been already explained with regard to the first embodiment.

According to the present embodiment, only by setting a currency of money to be handled by means of the currency setting unit 66, the display style set by the style setting unit 61 is automatically determined depending on the currency set by the currency setting unit 66. Therefore, when the currency of money and the display style for the digit grouping separator and the amount point correspond to each other on a one-to-one basis, the present embodiment is advantageous. The setting operation at the currency setting unit 66 can be executed by means of a pulldown menu selection screen, for example. According to such a currency selection, automatically, the display style for the digit grouping separator and the amount point as well as the locations of the digit grouping separator and the amount point can be determined.

Even when the currency of money and the display style for the digit grouping separator and the amount point do not correspond to each other on a one-to-one basis, the display style for the digit grouping separator and the amount point as well as the locations of the digit grouping separator and the amount point may be determined primarily. If the display style for the digit grouping separator, the display style for the amount point, the location of the digit grouping separator and the location of the amount point that have been determined by the currency selection are in consistence with the user's desire, the user can use them as they are. On the other hand, if the display style for the digit grouping separator, the display style for the amount point, the location of the digit grouping separator and the location of the amount point that have been determined by the currency selection are not in consistence with the user's desire, the user can set them again by means of the style setting unit 61 by operating the personal computer with a browser function 300.

In addition, according to the present embodiment, when no money of ancillary unit for the currency of money to be handled is in circulation, the display control unit 65 causes the display screen 10 not to display the amount point and figures after the amount point. Thus, the unnecessary amount point and the unnecessary figures after the amount point are not displayed, so that the amount of money can be displayed on the display screen 10 in consistence with the actual conditions of transactions more surely. For example, when “yen” is set as a currency of money, since money of “sen” as the ancillary unit is not in circulation, the amount point and figures after the amount point are not displayed.

Concrete examples are explained hereafter.

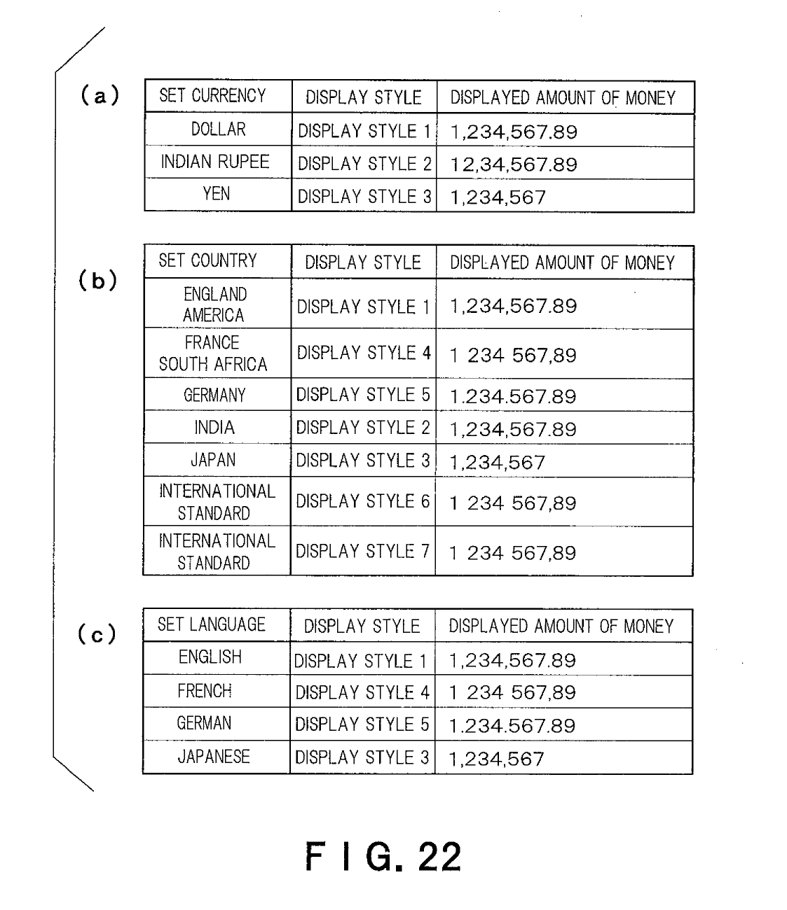

When the currency of money set by the currency setting unit 66 is dollar, a comma is set as the display style for the digit grouping separator, and a period is set as the display style for the amount point. As an example, “1,234,567.89” is displayed (see the display style 1 in FIG. 22(a)).

When the currency of money set by the currency setting unit 66 is Indian rupee, a comma is set as the display style for the digit grouping separator, a period is set as the display style for the amount point, and the location of the digit grouping separator is set after each 2n digits, such as four digits, six digits, eight digits, and the like. As an example, “12,34,567.89” is displayed (see the display style 2 in FIG. 22(a)).

When the currency of money set by the currency setting unit 66 is yen, a comma is set as the display style for the digit grouping separator, and it is determined that the amount point and the figures after the amount point are not displayed. As an example, “1,234,567” is displayed (see the display style 3 in FIG. 22(a)).

### Third Embodiment

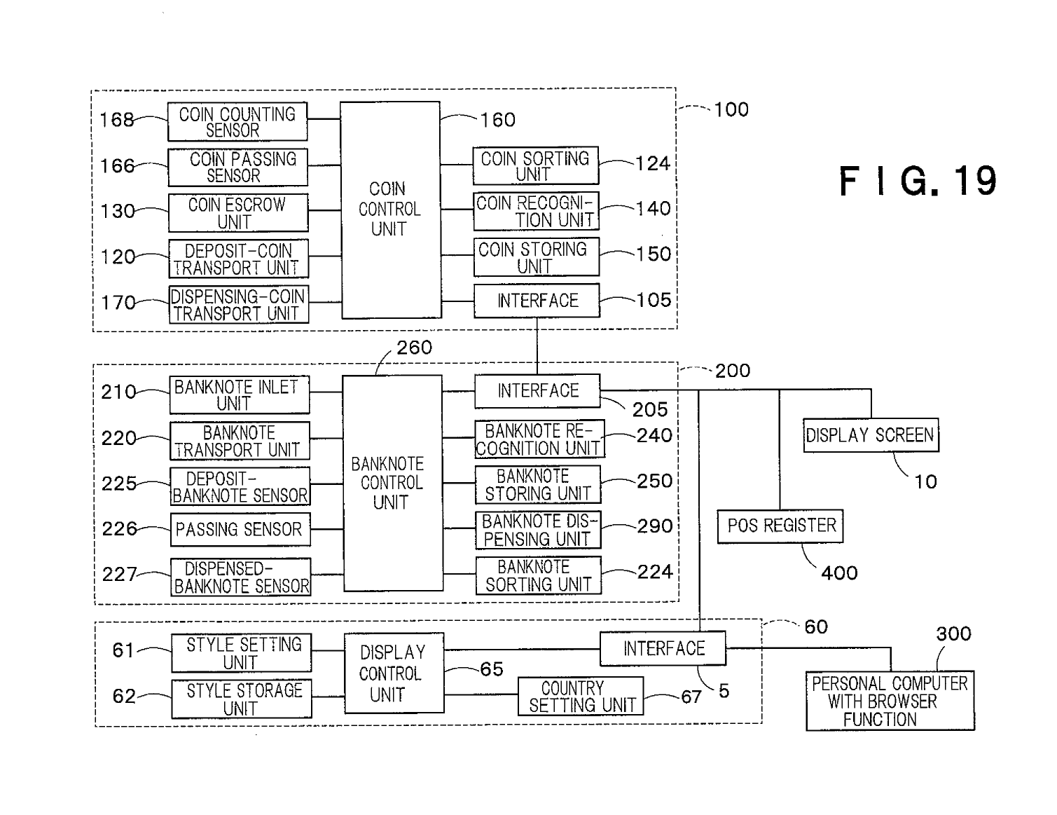

Next, mainly with reference to FIGS. 19 to 21, a third embodiment of the present invention is explained.

In addition to the matters explained in the first embodiment, according to the third embodiment, provided is a country setting unit 67 configured to set a country where the money handling system is to be used. Then, the display style set by the style setting unit 61 is automatically determined depending on the country set by the country setting unit 67. In the present embodiment, a BOX personal computer 60 has the country setting unit 67. However, the present invention is not limited thereto. An outside apparatus different from the money settlement apparatus 100, 200 may have the country setting unit 67.

The other structure of the third embodiment is substantially the same as that of the first embodiment. In the third embodiment, the same parts as the first embodiment are shown by the same reference numerals, and detailed explanation thereof is omitted.

According to the third embodiment as well, the same effects as the first embodiment can be achieved. Unique portions of the effects of the third embodiments are explained hereafter since the same effects have been already explained with regard to the first embodiment.

According to the present embodiment, only by setting a country where the money handling system 100, 200 is installed by means of the country setting unit 67, the display style set by the style setting unit 61 is automatically determined depending on the country set by the country setting unit 67. In general, the display style for the digit grouping separator and the amount point as well as the locations of the digit grouping separator and the amount point have been determined for each country. Thus, if the country is set by the country setting unit 67, the display style for the digit grouping separator, the display style for the amount point, the location of the digit grouping separator and the location of the amount point are in consistence with the user's desire with a higher probability.

If the display style for the digit grouping separator, the display style for the amount point, the location of the digit grouping separator and the location of the amount point that have been determined by the country setting are not in consistence with the user's desire, the user can set them again by means of the style setting unit 61 by operating the personal computer with a browser function 300.

Concrete examples of the present embodiment are explained hereafter.

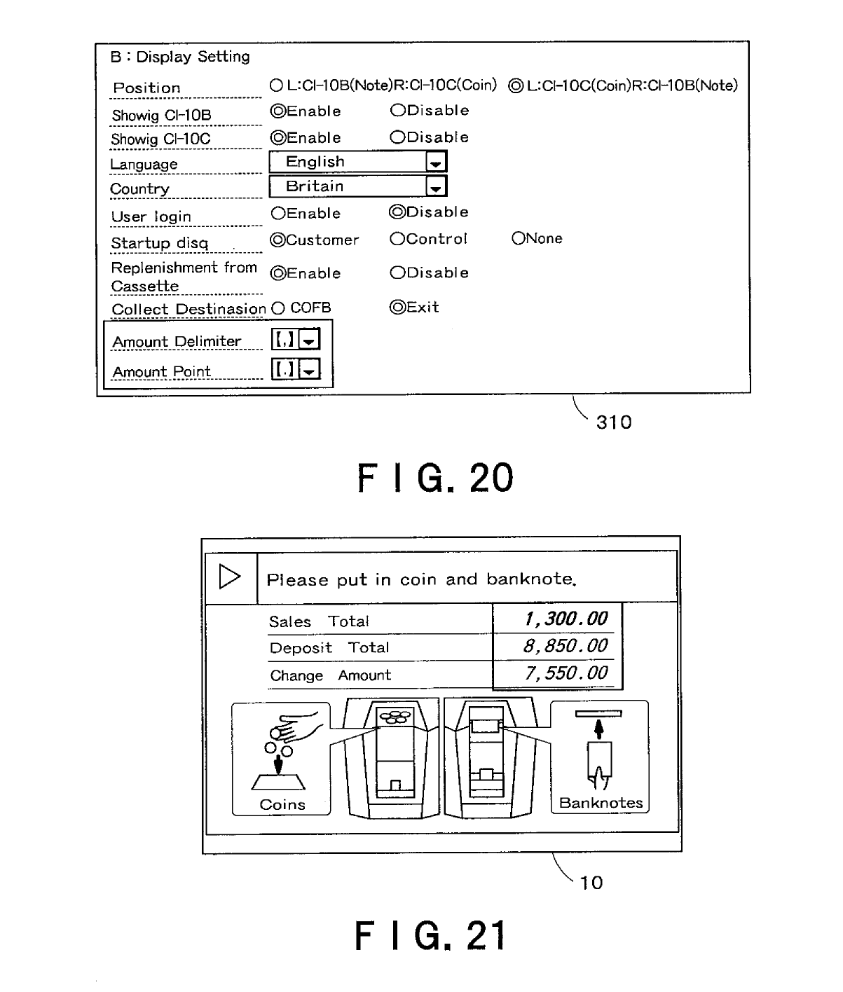

When the country that has been set by the country setting unit 67 is the United Kingdom or the United States of America, a comma is set as the display style for the digit grouping separator, and a period is set as the display style for the amount point. As an example, “1,234,567.89” is displayed (see the display style 1 in FIG. 22(b)). A more specific example is explained with reference to FIGS. 20 and 21. As shown in FIG. 20, “the United Kingdom (Britain)” is selected and set by means of a pulldown menu selection screen for the country selection. Then, as shown by a rectangular frame in FIG. 20, a comma is set as the digit grouping separator, and a period is set as the amount point. Therefore, the amount of money is displayed as shown in FIG. 21, for example.

When the country that has been set by the country setting unit 67 is France or the Republic of South Africa, a space is set as the display style for the digit grouping separator, and a comma is set as the display style for the amount point. As an example, “1 234 567,89” is displayed (see the display style 4 in FIG. 22(b)).

When the country that has been set by the country setting unit 67 is Germany, a period is set as the display style for the digit grouping separator, and a comma is set as the display style for the amount point. As an example, “1.234.567,89” is displayed (see the display style 5 in FIG. 22(b)).

When the country that has been set by the country setting unit 67 is India, a comma is set as the display style for the digit grouping separator, a period is set as the display style for the amount point, a location of the digit grouping separator is set after each 2n digits, such as four digits, six digits, eight digits, and the like. Herein, “n” is any integer more than one. As an example, “12,34,567.89” is displayed (see the display style 2 in FIG. 22(b)).

In the above description, the third embodiment is explained based on the first embodiment. However, the third embodiment is applicable to the second embodiment as well. In the latter case, the display style for the digit grouping separator and the amount point as well as the locations of the digit grouping separator and the amount point may be determined by the currency setting by means of the currency setting unit 66, or the display style for the digit grouping separator and the amount point as well as the locations of the digit grouping separator and the amount point may be determined by the country setting by means of the country setting unit 67.

Herein, when money of ancillary unit is not in circulation in the country set by the country setting unit 67, the display control unit 65 may cause the display screen 10 not to display the amount point and figures after the amount point. If this manner is adopted, the unnecessary amount point and the unnecessary figures after the amount point are not displayed, so that the amount of money can be displayed on the display screen 10 in consistence with the actual conditions of transactions more surely. For example, when “Japan” is set as a country, since money of “sen” as the ancillary unit is not any more in circulation in Japan, the amount point and figures after the amount point are not displayed. More specifically, when the country set by the country setting unit 67 is Japan, a comma is set as the display style for the digit grouping separator, and it is determined that the amount point and the figures after the amount point are not displayed. As an example, “1,234,567” is displayed (see the display style 3 in FIG. 22(b)).

Furthermore, the country setting unit 67 of the present embodiment can select “international standard”. Then, when the “international standard” is selected, the display style in consistence with the determination by the 22th General Conference of Weights and Measures, in which a period or a comma is used as an amount point and a space is used as a digit grouping separator, is set by the style setting unit 61. As an example, “1 234 567.89” or “1 234 567,89” is displayed (see the display styles 6 and 7 in FIG. 22(b)).

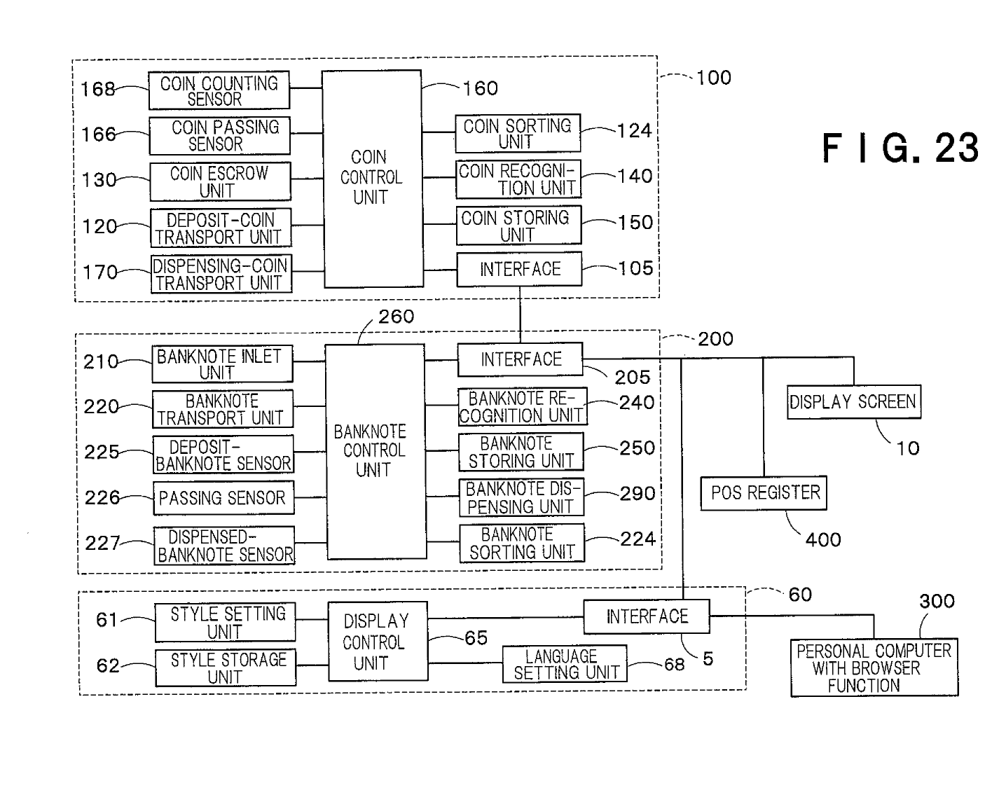

In the second embodiment, the currency is set by the currency setting unit 66, and in the third embodiment, the country is set by the country setting unit 67. Instead of them or in addition to them, there may be provided a language setting unit 68 configured to select a language (see FIG. 23). In this manner, the display style set by the style setting unit 61 is automatically determined depending on the language set by the language setting unit 68. In the embodiment shown in FIG. 23, a BOX personal computer 60 has the language setting unit 68. However, the present invention is not limited thereto. An outside apparatus may have the language setting unit 68.

Regarding the manner in which the language setting unit 68 is provided, concrete examples are explained hereafter. The setting operation at the language setting unit 68 is executed by means of a pulldown menu selection screen, for example (see FIG. 9). According to such a language selection, automatically, the display style for the digit grouping separator and the amount point as well as the locations of the digit grouping separator and the amount point can be determined (see a rectangular frame in FIG. 9).

When the language that has been set by the language setting unit 68 is English, a comma is set as the display style for the digit grouping separator, and a period is set as the display style for the amount point. As an example, “1,234,567.89” is displayed (see the display style 1 in FIG. 22(c)).

When the language that has been set by the language setting unit 68 is French, a space is set as the display style for the digit grouping separator, and a comma is set as the display style for the amount point. As an example, “1 234 567,89” is displayed (see the display style 4 in FIG. 22(c)).

When the language that has been set by the language setting unit 68 is German, a period is set as the display style for the digit grouping separator, and a comma is set as the display style for the amount point. As an example, “1.234.567,89” is displayed (see the display style 5 in FIG. 22(c)).

When the language that has been set by the language setting unit 68 is Japanese, a comma is set as the display style for the digit grouping separator, and it is determined that the amount point and the figures after the amount point are not displayed. As an example, “1,234,567” is displayed (see the display style 3 in FIG. 22(c)).

### Fourth Embodiment

Next, a fourth embodiment of the present invention is explained.

In addition to the matters explained in the first embodiment, according to the fourth embodiment, when the amount point is set by the style setting unit 61, the display style for the digit grouping separator different from the amount point is automatically set, and/or when the digit grouping separator is set by the style setting unit 61, the display style for the amount point different from the digit grouping separator is automatically set.

The other structure of the fourth embodiment is substantially the same as that of the first embodiment. In the fourth embodiment, the same parts as the first embodiment are shown by the same reference numerals, and detailed explanation thereof is omitted.

According to the fourth embodiment as well, the same effects as the first embodiment can be achieved. Unique portions of the effects of the fourth embodiments are explained hereafter since the same effects have been already explained with regard to the first embodiment.

According to the fourth embodiment, when the amount point is set by the style setting unit, the display style for the digit grouping separator different from the set amount point is automatically set. Similarly, when the digit grouping separator is set by the style setting unit, the display style for the amount point different from the set digit grouping separator is automatically set. In general, the display style for the amount point and the display style for the digit grouping separator are different. Thus, according to the fourth embodiment, the display style for the amount point and the display style for the digit grouping separator can be set easily, which can reduce the possibility that they would be set wrongly.

Concrete examples of the present embodiment are explained hereafter.

As a first manner, when a comma is set as the display style for the digit grouping separator by the style setting unit 61, a period is automatically set as the display style for the amount point; and/or when a period is set as the display style for the amount point by the style setting unit 61, a comma is automatically set as the display style for the digit grouping separator. The present manner is advantageous for cases in which the money handling apparatus 100, 200 is installed in the United Kingdom, the United States of America, India, or the like.

As a second manner, when a comma is set as the display style for the amount point by the style setting unit 61, a space or a period is automatically set as the display style for the digit grouping separator; and/or when a space or a period is set as the display style for the digit grouping separator by the style setting unit 61, a comma is automatically set as the display style for the amount point. The present manner is advantageous for cases in which the money handling apparatus 100, 200 is installed in France, the Republic of South Africa, Germany, or the like.

The second manner can be divided into two detailed manners: specifically, an A manner in which, when a comma is set as the display style for the amount point by the style setting unit 61, a space is automatically set as the display style for the digit grouping separator, and/or when a space is set as the display style for the digit grouping separator by the style setting unit 61, a comma is automatically set as the display style for the amount point; and a B manner in which, when a comma is set as the display style for the amount point by the style setting unit 61, a period is automatically set as the display style for the digit grouping separator, and/or when a period is set as the display style for the digit grouping separator by the style setting unit 61, a comma is automatically set as the display style for the amount point.

The above A manner is advantageous for cases in which the money handling apparatus 100, 200 is installed in France, the Republic of South Africa or the like. On the other hand, the above B manner is advantageous for cases in which the money handling apparatus 100, 200 is installed in Germany or the like.

As a third manner, when a period or a comma is set as the display style for the amount point by the style setting unit 61, a space is automatically set as the display style for the digit grouping separator; and/or when a space is set as the display style for the digit grouping separator by the style setting unit 61, a period or a comma is automatically set as the display style for the amount point. The present manner is advantageous for cases in which the display style in consistence with the determination by the 22th General Conference of Weights and Measures is adopted.

In the above description, the fourth embodiment is explained based on the first embodiment. However, the fourth embodiment is applicable to the second embodiment or the third embodiment as well. The fourth embodiment is also applicable to the combination of the second embodiment and the third embodiment as well. The fourth embodiment is also applicable to the embodiments using the language setting unit 68.

At last, the description of the above respective embodiments and the disclosure of the drawings are only exemplary for explaining the present invention defined in the attached claims. The scope of claim of the present invention is not limited by the description of the above respective embodiments and the disclosure of the drawings.

1. A money handling system comprising:
a money handling apparatus configured to handle money;
an amount-of-money display unit configured to display an amount of money handled by the money handling apparatus;
a style setting unit configured to set a display style for an amount point or a digit grouping separator, which is used when the amount of money is displayed on the amount-of-money display unit;
a storage unit configured to store the display style set by the style setting unit; and
a control unit configured to cause the amount-of-money display unit to display the amount of money with the use of the display style stored in the storage unit.

2. The money handling system according to claim 1, further comprising an outside apparatus different from the money handling apparatus, wherein
the style setting unit is located in the outside apparatus, and
the display style set by the style setting unit is stored in the storage unit via a communication unit.

3. The money handling system according to claim 1, wherein
the money handling apparatus is a money settlement apparatus configured to dispense money whose amount corresponds to a difference between an amount of deposit money and an amount of sales, and
the amount-of-money display unit is configured to display the amount of sales, the amount of deposit money, the amount of change corresponding to the difference between the amount of deposit money and the amount of sales.

4. The money handling system according to claim 1, wherein
the style setting unit is configured to further set a location of the digit grouping separator, and
the storage unit is configured to further store the location of the digit grouping separator set by the style setting unit.

5. The money handling system according to claim 1, wherein
the display style for the digit grouping separator is selectable from a group having at least two of a comma, a period, an apostrophe and a space, and
one display style selected from the group can be selectively set as the display style for the digit grouping separator by means of the style setting unit.

6. The money handling system according to claim 1, wherein
the display style for the amount point is selectable from a comma and a period, and
the comma or the period can be selectively set as the display style for the amount point by means of the style setting unit.

7. The money handling system according to claim 1, further comprising a currency setting unit configured to set a currency of money to be handled, wherein
the display style set by the style setting unit is automatically determined depending on the currency set by the currency setting unit.

8. The money handling system according to claim 1, further comprising a country setting unit configured to set a country where the money handling system is to be used, wherein
the display style set by the style setting unit is automatically determined depending on the country set by the country setting unit.

9. The money handling system according to claim 8, wherein
when the country set by the country setting unit is the United Kingdom or the United States of America, a comma is set as the display style for the digit grouping separator, and a period is set as the display style for the amount point.

10. The money handling system according to claim 8, wherein
when the country set by the country setting unit is France or the Republic of South Africa, a space is set as the display style for the digit grouping separator, and a comma is set as the display style for the amount point.

11. The money handling system according to claim 8, wherein
when the country set by the country setting unit is Germany, a period is set as the display style for the digit grouping separator, and a comma is set as the display style for the amount point.

12. The money handling system according to claim 8, wherein
when the country set by the country setting unit is India, a comma is set as the display style for the digit grouping separator, a period is set as the display style for the amount point, a location of the digit grouping separator is set after each 2n digits (“n” is any integer more than one) after the amount point.

13. The money handling system according to claim 1, wherein
when the amount point is set by the style setting unit, the display style for the digit grouping separator different from the amount point is automatically set, and
when the digit grouping separator is set by the style setting unit, the display style for the amount point different from the digit grouping separator is automatically set.

14. The money handling system according to claim 13, wherein
when a comma is set as the display style for the digit grouping separator by the style setting unit, a period is automatically set as the display style for the amount point, and
when a period is set as the display style for the amount point by the style setting unit, a comma is automatically set as the display style for the digit grouping separator.

15. The money handling system according to claim 13, wherein
when a comma is set as the display style for the amount point by the style setting unit, a space or a period is automatically set as the display style for the digit grouping separator, and
when a space or a period is automatically set as the display style for the digit grouping separator by the style setting unit, a comma is automatically set as the display style for the amount point.

16. The money handling system according to claim 13, wherein
when a period or a comma is set as the display style for the amount point by the style setting unit, a space is automatically set as the display style for the digit grouping separator, and
when a space is automatically set as the display style for the digit grouping separator by the style setting unit, a period or a comma is automatically set as the display style for the amount point.

17. The money handling system according to claim 1, further comprising a currency setting unit configured to set a currency of money to be handled, wherein
when no money of ancillary unit for the currency of money to be handled is in circulation, the control unit causes the amount-of-money display unit not to display the amount point and figures after the amount point.

18. The money handling system according to claim 1, further comprising a country setting unit configured to set a country where the money handling system is to be used, wherein
when no money of ancillary unit is in circulation in the country set by the country setting unit, the control unit causes the amount-of-money display unit not to display the amount point and figures after the amount point.

19. A money handling apparatus comprising:
an amount-of-money display unit configured to display an amount of money handled by the money handling apparatus;
a storage unit configured to store a display style for an amount point or a digit grouping separator, which is set by a style setting unit; and
a control unit configured to cause the amount-of-money display unit to display the amount of money with the use of the display style stored in the storage unit.

20. A money handling method comprising:
setting a display style for an amount point or a digit grouping separator by means of a style setting unit;
storing the display style set by the style setting unit in a storage unit;
handling money by means of a money handling apparatus; and
displaying on an amount-of-money display unit an amount of money with the display style stored in the storage unit, during the handling.
